(19) United States
(12) Patent Application Publication
(10) Pub. No.: US 2010/0005923 A1
(43) Pub. Date: Jan. 14, 2010

(54) BICYCLE PEDAL

(76) Inventor: Chung-I Chen, Taichung Hsien (TW)

Correspondence Address: Chien-Hui Su, P. O. Box 70-121 Taichung, Taichung City, 40899, TW

(21) Appl. No.: 12/170,442

(22) Filed: Jul. 10, 2008

(51) Int. Cl. B62M 3/10

(52) U.S. Cl. 74/594.6

(57) ABSTRACT

A bicycle pedal comprises a pedal body having two pairs of wings extended from two opposite sides of the pedal body; a pivot shaft passing through the receiving space of the pair of wings for assembling with a press unit and an adjusting hook; a positioning hook being installed adjacent to the adjusting hook; the press units resist against the pedal body and the adjusting hook for providing a clamping force to the adjusting hook; each adjusting hook having a clamping portion; and each clamping portion having an adjusting stud which resists against the press units; and the adjusting stud being vertical to a treading surface of the pedal body; by tightening or releasing the adjusting stud, the clamping force of the adjusting hook is adjustable. The components above mentioned is updateable easily and conveniently and can be cleaned easily; and the adjustment of the clamping force is adjusted conveniently.

### FIELD OF THE INVENTION

The present invention relates to bicycle pedals, especially to a bicycle pedal having a simple structure, capable of being updated easily, providing a uniform clamping force and capable of being adjusted conveniently and being cleaned easily.

### BACKGROUND OF THE INVENTION

Bicycles are environmental protected vehicles which can be parked conveniently and can be operated easily, can be driven rapidly or slowly as desired so that they are suitable for people of various ages and thus is a main trend in current exercise.

To improve the quality and function of bicycles to match the requirement of drivers, a bicycle pedal is also taken into consideration so that the driver's toe can be well matched to the pedal without falling out and thus no accident occurs. In one improvement, Taiwan Patent No. M250874, “Mounting climbing pedal”, it that, the pedal has a pedal shaft and a pedal body with four wings. The wings are arranged as two pairs which are arranged with a fixed damper and an active damper for clamping a toe positioner to clamp the toes of the driver. An adjusting screw of a damper clamps and an adjusting unit serves to tighten or release a shift unit so as to adjust the tightness of the toe positioner.

However, in the clamping mechanism of the pedal which is formed by the active damper and the fixed clamper, the adjust screw for adjusting the shift unit is at another side of the pedal. In adjusting of the shift unit, it must in advance turn over the pedal for adjustment. One side of the shift unit resists against the adjusting screw and adjust unit. The force is not uniformly distributed so as to affect the steadiness that the clamping mechanism to clamp the toe positioner. The adjusting screw applies force to the shift unit through the adjusting unit. No larger twisting force is used for driving the adjusting unit. Furthermore, a plurality of elements is used for performing only one function. The structure is complicated. Furthermore, the whole structure of the active damper has a close form which is not suitable for cleaning dirt or dusts therein. For a long time, the adjusting screw, adjusting unit and shift unit will rust and the preciseness of the elastic coefficient will be destroyed.

Furthermore, in Taiwan Patent No. 413212, “Suspending pedal”, an H shape pedal has two locks longitudinally arranged with opposite orientations. A same side of the lock is formed with a front and a rear hook. Each lock has a transversal lock block. Each of two sides of the lock block has a plate and an adjusting screw for adjusting the tightness of the lock block so that the front and rear hooks can clamp the toe positioner at the leg bottom of the driver.

However in this structure, a plate and an adjusting screw serve to adjust the lock block, while the structure is complicated. Moreover, the plate for clamping the toe positioner easily rusts or deform and thus is necessary to be updated. In updating, the locks, lock blocks, adjusting screws, plates are necessary to be detached for updating. The operation is inconvenient. In the clamping structure, the adjusting screw, plates of the locks, locking blocks and plates are enclosed one by one sequentially. It is difficult to clean the dirt and sands therein. As a result, the locks of the locking blocks, plates, adjusting screws will shorten the lifetime of the pedal. In updating these elements, it is necessary to detach all these elements. It is a tedious and trouble work.

### SUMMARY OF THE INVENTION

Accordingly, the object of the present invention is to provides a bicycle pedal which has a simple structure and the adjusting of the clamping force is easy and convenient with an uniform force distribution. Moreover it is difficult to accumulate sands and dirt.

To achieve above object, the present invention provides a bicycle pedal, comprising: a pedal body having two pairs of wings which are extended from two opposite sides of the pedal body; an orientation of one pair of wings being opposite to that of another one; each wing has a respective resisting block facing to another resisting block of another wing of the same pair; a receiving space being formed between two wings of the same pair; a pivot shaft passing through the receiving space for assembling with a press unit and an adjusting hook; the press unit being within the adjusting hook; a positioning hook being installed adjacent to the adjusting hook so that the positioning hook is aligned to and face to a respective one of the adjusting hook; and the adjusting hook and the positioning hook serve to clamp an object;

Each wing has a respective resisting block facing to another resisting block of another wing of the same pair; the resisting block serves to resist against the press unit. Each one of the press unit is extended with a resisting end for resisting against the resisting block and is extended with a pressed end which resists against the clamping portion of the adjusting hook.

Each adjusting hook is formed with clamping portion for resisting a front end of a toe positioner and a buckling portion resisted by the pressed end of the press unit. Each buckling portion is installed with a limiting body for preventing the shift of the press unit and an adjusting stud which passes through adjusting holes of each adjusting hook to resist against the press unit. Each adjusting holes is vertical to a treading surface of the pedal body. Each end of the buckling portion is extended with a connecting arm. The positioning hook has a positioning portion for retaining a rear end of the toe positioner.

The positioning hook at one side of the pedal body is corresponding to the adjusting hook at the same side and opposite direction. The adjusting hook serves to clamp and fix the toe positioner. By the adjusting stud to tighten or release the press unit, the connecting arm is driven by the press unit to shift so as to change the tightness between the adjusting hook and the positioning hook at the same side and opposite direction so as to provide different clamping force to the toe positioner.

Advantages of the present invention will be described herein.

1. The adjusting stud applies force to the control unit directly so that the structure is simple and less force is used.

2. The pressed end of the control unit suffers from a force from the adjusting stud so that the force is uniformly applied to the control unit so that the positioning hook applies a uniform clamping force to the toe positioner. The adjusting stud is a top of the pedal body so that the adjusting operation can be performed conveniently.

3. The positioning hook and the adjusting hook are installed separately.

In updating, it is only necessary to detach the positioning hook, it is unnecessary to detach the whole structure. Less operation is performed. Especially, the adjusting operation will not affect the tightness of the adjusting stud, the adjusting hook, control unit, etc.

4. The adjusting hook and positioning hook assembled to the wing pairs will not affect the control unit. The limiting body serves to prevent the shift. The present invention provides a preferred open space and firm structure. The dirt or sands attached thereon can be cleaned conveniently. No rust generates.

The various objects and advantages of the present invention will be more readily understood from the following detailed description when read in conjunction with the appended drawing.

### BRIEF DESCRIPTION OF THE DRAWINGS

FIG. 1 is an exploded perspective view of the bicycle pedal of the present invention.

FIG. 2 is a perspective view of the present invention.

FIGS. 3 and 4 are schematic views of the present invention, which are viewed from different visual angles.

FIG. 5 is a schematic view showing the assembly of the toe positioner of the present invention.

FIG. 6 is a schematic view showing the application of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

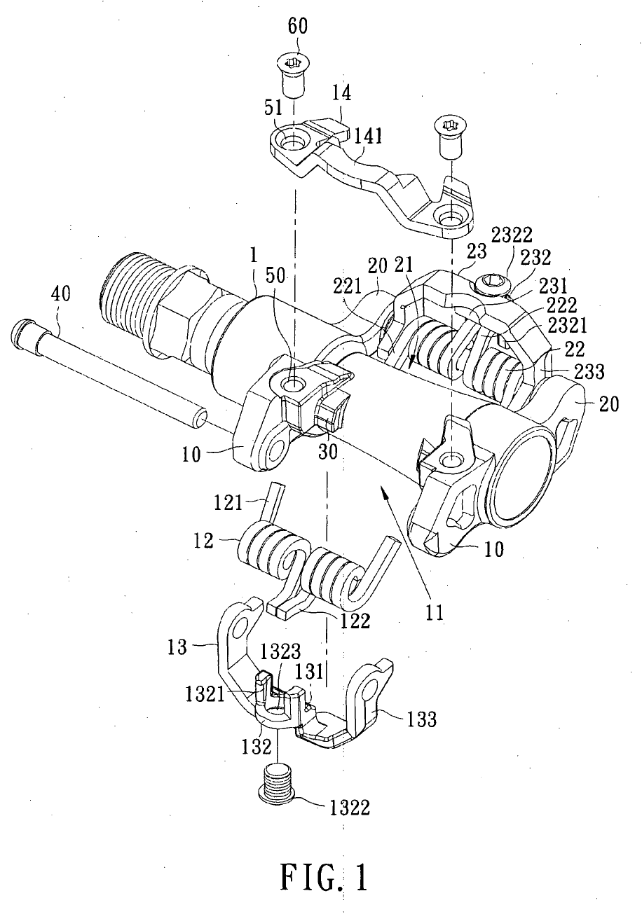

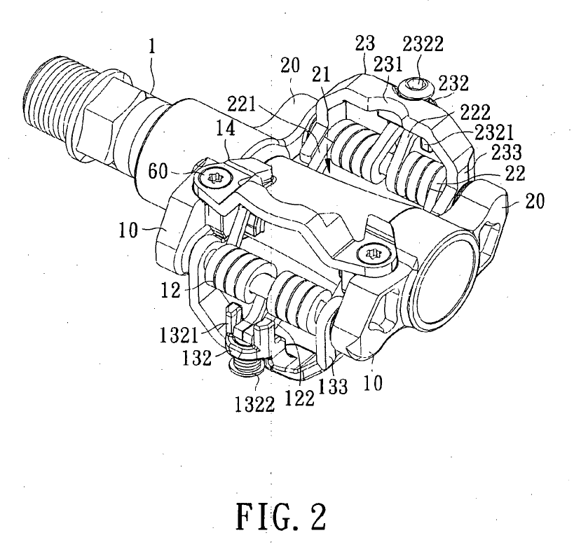

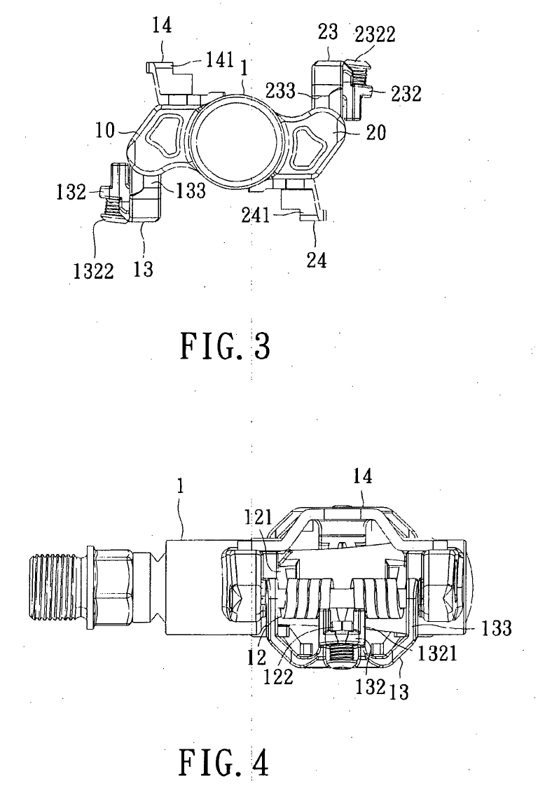

Referring to FIGS. 1 to 4, the bicycle pedal of the present invention is illustrated. The present invention includes a pedal body 1. Each of two opposite sides of the pedal body 1 is extended with a pair of wings 10, 20. Each wing 10, 20 has a respective resisting block 30. Two resisting blocks 30 of the same pair of the wings 10, 20 face to one another. The orientation of the wings 10 is opposite to that of the wings 20. Each pair of wings 10, 20 is formed with a receiving space 11, 21 therebetween. For each pair of wings 10, 20, a pivot shaft 40 passes through the receiving space 11, 21 transversally. Each pivot shaft 40 is assembled with a press unit 12, 22 and an adjusting hook 13, 23. The press unit 13, 23 is a spring and is arranged between two arms of the adjusting hook 13, 23. Each wing 10, 20 has a through hole 50. Each pair of the wing 10, 20 has a positioning hook 14, 24. Each of two sides of each positioning hook has a through hole 51 arranged corresponding to the through hole 50 of the adjusting hook. Each through hole 50 of the wing 10, 20 and each through hole 51 of the positioning hook 14, 24 are locked by a lock 60.

Each of two arms of each press unit 12, 22 is formed as a resisting end 122, 222 corresponding to the resisting block 30 of the wing 10, 20. A middle section of the press unit 12, 22 is extended with a pressed end 122, 222. By the resisting ends 121, 221 and the pressed ends 122, 222, the press units 12, 22 will resist against the pedal body 1 and the adjusting hooks 13, 23 so as to provide the adjusting hooks 13, 23 with clamping forces.

Each adjusting hook 12, 23 is formed with clamping portion 131, 231 for resisting a front end of a toe positioner and a buckling portion 132, 232 resisted by the pressed end 122, 222 of the press unit 12, 22. Each buckling portion 132, 232 is installed with a limiting body 1321, 2321 for preventing the shift of the press unit 12, 22 and an adjusting stud 1322, 2322 which passes through adjusting holes 1323, 2323 of each adjusting hook 13, 23 to resist against the press unit 12, 22. Each adjusting holes 1323, 2323 is vertical to a treading surface of the pedal body 1. Each end of the buckling portion 132, 232 is extended with a connecting arm 133, 233. Each connecting arm 133, 233 is passed by the pivot shaft 40 and is interacted with the press unit 12, 22. The positioning hook 14, 24 has a positioning portion 141, 241 for retaining a rear end of the toe positioner.

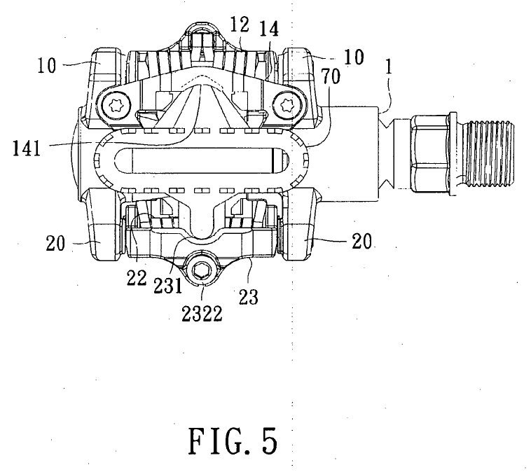

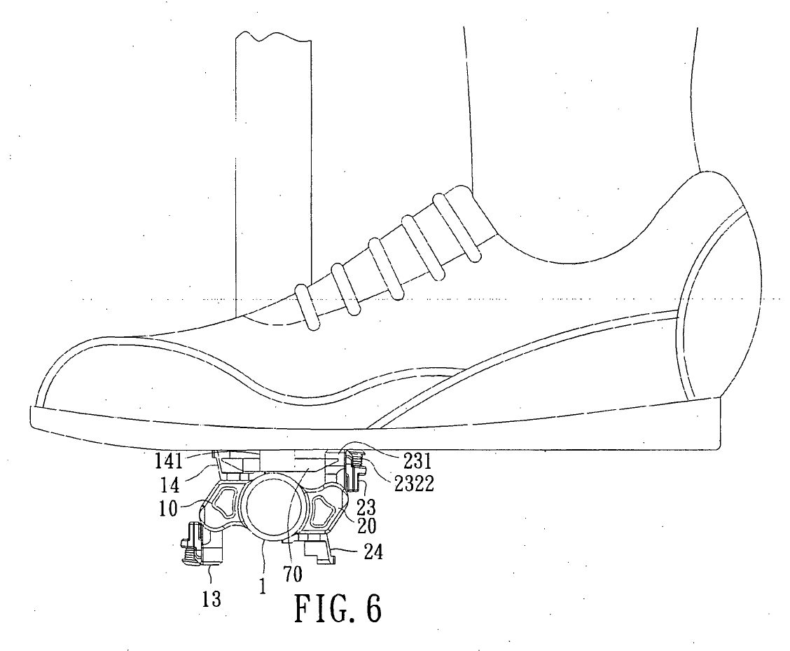

Referring to FIGS. 5, 6, the positioning hook 14, 24 at one side of the pedal body 1 is corresponding to the adjusting hook 13, 23 at the same side and opposite direction. The adjusting hook 13, 23 serves to clamp and fix the toe positioner 70. By the adjusting stud 1322, 2322 to tighten or release the press unit 12, 22, the connecting arm 133, 233 is driven by the press unit 12, 22 to shift so as to change the tightness between the adjusting hook 12, 23 and the positioning hook 14, 24 at the same side and opposite direction so as to provide different clamping force to the toe positioner 70.

In the present invention, the adjusting stud 1322, 2322 serve to apply force to the press unit 12, 22 directly. No interface element is used. Not only the structure is simplified, but also smaller force is used to rotating the adjusting stud 1322, 2322 to drive the press unit 12, 22. Furthermore, the press unit 12, 22 is a spring. The pressed end 122, 222 at the middle section of the press unit 12, 22 is pressed by the adjusting stud 1322, 2322, and thus the adjusting hook 13, 23 will provide a uniform clamping force to the toe positioner 70. The adjusting stud 1322, 2322 is at a top of the pedal body 1. It is unnecessary to insert a hand into another side of the pedal, or it is unnecessary to turn over the pedal for adjusting. Moreover, the positioning hook 13, 23 is separated from the adjusting hook 13, 23, if it is necessary to be updated, it is only necessary to detach or update the positioning hook 14, 24 without needing to detach all elements. The process is simplified. Finally, the adjusting hook 13, 23 and the positioning hook 14, 24 of the same wing 10, 20 are formed and arranged to the press unit 12, 22. The limiting unit 1321, 2321 serves to prevent the shift thereof. Thus, the present invention has the advantages of providing an open space and a stable structure. The dirt on the components can be cleaned conveniently. The possibility of rusting is reduced.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A bicycle pedal, comprising: a pedal body having two pairs of wings which extend from two opposite sides of the pedal body; an orientation of one pair of wings being opposite to that of another one; a receiving space being formed between two wings of the same pair; a pivot shaft passing through the receiving space for assembling with a press unit and an adjusting hook; the press unit being within the adjusting hook; a positioning hook being installed adjacent to the adjusting hook so that the positioning hook is aligned to and face to a respective one of the adjusting hook; and the adjusting hook and the positioning hook serve to clamp an object;
the press units resist against the pedal body and the adjusting hook for providing a clamping force to the adjusting hook; each adjusting hook having a clamping portion; and each clamping portion having an adjusting stud which resists against the press units; and the adjusting stud being vertical to a treading surface of the pedal body; by tightening or releasing the adjusting stud, the clamping force of the adjusting hook is adjustable; and
wherein the components above mentioned is updateable easily and conveniently and can be cleaned easily; and the adjustment of the clamping force is adjusted conveniently.

2. The bicycle pedal as claimed in claim 1, wherein each adjusting hook is formed with clamping portion for resisting a toe positioner; and an adjusting hole for installing the adjusting stud; the pivot shaft passing through two connecting arms at two ends of each adjusting hook; each connecting arm being shiftable by controlling the press units so as to adjust the tightness between the adjusting hook and a respective one of the positioning hooks at a same side and orientated oppositely to provide different clamping force; the positioning hook having a positioning portion for retaining the toe positioner; and the positioning portion having through holes corresponding to through holes of the pedal body so as to lock the positioning portion to the pedal body.

3. The bicycle pedal as claimed in claim 1, wherein each wing has a respective resisting block facing to another resisting block of another wing of the same pair; the resisting block serves to resist against the press unit; one of the press unit is extended with a resisting end for resisting against the resisting block and is extended with a pressed end which resists against the clamping portion of the adjusting hook.

4. A bicycle pedal, comprising: a pedal body having two pairs of wings which extend from two opposite sides of the pedal body; an orientation of one pair of wings being opposite to that of another one; a receiving space being formed between two wings of the same pair; a pivot shaft passing through the receiving space for assembling with a press unit and an adjusting hook; the press unit being within the adjusting hook; a positioning hook being installed adjacent to the adjusting hook so that the positioning hook is aligned to and face to a respective one of the adjusting hook; and the adjusting hook and the positioning hook serve to clamp an object;
the press units resisting against the pedal body and the adjusting hook for providing a clamping force to the adjusting hook; each adjusting hook having a clamping portion; and each clamping portion having a limiting body and an adjusting stud; the limiting body serving for preventing the press units to shift away; and the adjusting stud resisting against the press units; and the adjusting stud being vertical to a treading surface of the pedal body; by tightening or releasing the adjusting stud, the clamping force of the adjusting hook is adjustable; and
wherein the components above mentioned is updateable easily and conveniently and can be cleaned easily; the adjustment of the clamping force is adjusted conveniently.

5. The bicycle pedal as claimed in claim 4, wherein each adjusting hook is formed with clamping portion for resisting a toe positioner; and an adjusting hole for installing the adjusting stud; the pivot shaft passing through two connecting arms at two ends of each adjusting hook; each connecting arm being shiftable by controlling the press units so as to adjust the tightness between the adjusting hook and a respective one of the positioning hooks at a same side and orientated oppositely to provide different clamping force; the positioning hook has a positioning portion for retaining the toe positioner; and the positioning portion having through holes corresponding to through holes of the pedal body so as to lock the positioning portion to the pedal body.

6. The bicycle pedal as claimed in claim 4, wherein each wing has a respective resisting block facing to another resisting block of another wing of the same pair; the resisting block serves to resist against the press unit; one of the press unit is extended with a resisting end for resisting against the resisting block and is extended with a pressed end which resists against the clamping portion of the adjusting hook.
